(19) United States
(12) Patent Application Publication
(10) Pub. No.: US 2009/0094651 A1
(43) Pub. Date: Apr. 9, 2009

(54) Ethernet-Level Measurement of Multicast Group Delay Performance

(75) Inventors: Gerard Damm, Plano, TX (US); Kamakshi Sridhar, Plano, TX (US)

Correspondence Address: Law Office of WILLIAM J. TUCKER, 2631 Lakeforest Ct., Dallas, TX, 75214, US

(73) Assignee: ALCATEL LUCENT, PARIS (FR)

(21) Appl. No.: 11/869,713

(22) Filed: Oct. 9, 2007

(51) Int. Cl. H04N 7/173

(52) U.S. Cl. 725/93; 725/110

(57) ABSTRACT

A network management system and method are described herein that can measure on-demand the D/DV (Delay/Delay Variation) in a Broadcast Television (BTV) multicast stream for a group of listeners that are associated with an Internet Protocol Television (IPTV) network.

### TECHNICAL FIELD

The present invention is related to a network management system and method that can measure on-demand the D/DV (Delay/Delay Variation) in a Broadcast Television (BTV) multicast stream for a group of listeners that are associated with an Internet Protocol Television (IPTV) network.

### BACKGROUND

The following abbreviations are herewith defined, at least some of which are referred to in the ensuing description of the prior art and the present invention.

### BNG Broadband Network Gateway

### BTV Broadcast Television

### DA Destination Address

### DSL Digital Subscriber Line

### DSLAM Digital Subscriber Line Access Multiplexer

### EVC Ethernet Virtual Circuit

### FDB Forwarding Database

### GA Group Address

### IEEE Institute of Electrical and Electronics Engineers

### IETF Internet Engineering Task Force

### IGMP Internet Group Management Protocol

### IP Internet Protocol

### IPPM IP Performance Metrics

### IPTV Internet Protocol Television

### IWF Inter-Working Function

LT Line Termination (customer-side of a DSLAM)

### MEF Metro Ethernet Forum

NT Network Termination (network-side of a DSLAM)

### PIM Protocol-Independent Multicast

### MA Maintenance Association

### MAC Media Access Control

### MEP Maintenance End Point

### MIP Maintenance Intermediate Point

### MLD Multicast Listener Discovery

### NMS Network Management System

### OAM Operation, Administration and Maintenance

### OLT Optical Line Termination

### ONT Optical Network Termination

### PON Passive Optical Network

### RGW Residential Gateway

### RPF Reverse Path Forwarding

### Rx Receive

### TLV Type-Length-Value

### TS Time Stamp

### TV Television

### Tx Transmit

### VLAN Virtual Local Area Network

Referring to FIGS. 1-2 (PRIOR ART), there are two block diagrams of a traditional IPTV network 100 with Ethernet-based DSL aggregation (e.g., see DSL Forum TR-101). As shown, the traditional IPTV network 100 includes a regional network 102 which is coupled to a BNG 104 (which has a NMS 106 connected thereto) which is coupled to one or more aggregation nodes 108. The aggregation node(s) 108 are connected by an Ethernet access network 110 to multiple access nodes 112 (e.g., DSLAMs 112). The DSLAMs 112 are connected to multiple RGWs 114 which in turn are associated with multiple customers 116 (note: normally there is one customer 116 per one RGW 114). This basic architecture is well known to those skilled in the art but for additional details about this type of architecture reference is made to DSL Forum TR-101 Ethernet-based DSL aggregation dated April 2006 (the contents of which are hereby incorporated by reference herein).

In this IPTV network 100, all BTV traffic (multiple TV channels) at the Ethernet level (level 2) use the same VLAN (e.g., VLAN 32 shown in FIG. 2). A multicast stream 202 corresponds to a TV channel (e.g., CNN or Eurosport). The customer 116 is a “listener” if he/she has joined a particular multicast stream 202 by selecting the corresponding TV channel on a set-top box associated with their TV (note 1: all of the nodes/ports between the BNG 104 and the customer 116 would also be a “listener” of the particular multicast stream 202) (note 2: a “listener” is a L3 concept (i.e. IP layer) while at L2 (i.e. Ethernet) an IP-unaware device will just broadcast multicast traffic and if there is an IP-aware device then it will typically use IGMP snooping to propagate data downstream as if it were an actual L3 listener). Now, if the customer 116 is watching their television and they experience an unacceptable Delay or Delay Variation (“jitter”) for CNN, but not for Eurosport, then they may call a customer service representative and ask them to resolve this problem. In an attempt to resolve this problem, the customer service representation would likely want to verify the current D/DV performance of the given TV channel on the BTV VLAN, downstream of the BNG 104, for all the current listeners, so as to compare the group performance to the point-to-point performance of that particular customer 116. Unfortunately, with the state-of-the-art technology today, the customer service representative does not have the capability to measure on-demand the D/DV for a group of listeners of a BTV multicast stream. This need and other needs are satisfied by the network management system and method of the present invention.

### SUMMARY

In one aspect, the present invention provides a method for measuring a delay in a multicast stream for a group of listeners in an IP network. The method comprising the steps of: (1) sending a layer 2 multicast message (e.g., Ethernet OAM DMM frame) with a first transmit time and a multicast address of the multicast stream from an originating node towards a plurality of destination nodes; and (2) causing a layer 2 unicast message (e.g., Ethernet OAM DMR frame) to be sent from each of the destination nodes that are listeners of the multicast stream, where each layer 2 unicast message includes the first transmit time, the multicast address of the multicast stream and additional timing information which is used to measure the delay in the multicast stream for the group of listeners.

In yet another aspect, the present invention provides a network management system that has a processor which accesses instructions from a memory and processes those instructions to enable the following: (1) instruct an originating node to send a layer 2 multicast message (e.g., Ethernet OAM DMM frame) with a first transmit time and a multicast address of the multicast stream towards a plurality of destination nodes; and (2) cause each of the destination nodes that are listeners of the multicast stream to transmit a layer 2 unicast message (e.g., Ethernet OAM DMR frame) which includes the first transmit time, the multicast address of the multicast stream and additional timing information which is used to measure a delay in the multicast stream for a group of listeners.

In still yet another aspect, the present invention provides an IPTV network that includes: (1) a BNG; (2) an aggregation node coupled to the BNG; (3) a DSLAM coupled to the aggregation node via an Ethernet access network; (4) a RGW coupled to the DSLAM; and (5) a NMS coupled to the BNG. The NMS has a processor which accesses instructions from a memory and processes those instructions to enable the following: (1) instruct the BNG to send a layer 2 multicast DMM message with a first transmit time and a multicast address of the multicast stream towards the DSLAM; and (2) cause the DSLAM and in particular MEPs located therein that are listeners of the multicast stream to each transmit a layer 2 unicast DMR message which includes the first transmit time, the multicast address of the multicast stream and additional timing information which is used to measure a delay in the multicast stream for a group of listeners.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIGS. 1-2 (PRIOR ART) are two block diagrams of a traditional IPTV network which is used to help explain a technical problem that is solved by the present invention;

FIGS. 3-5 are diagrams of an IPTV network which has a NMS that implements a group measurement method to address the aforementioned technical problem in accordance with the present invention;

FIGS. 6-7 are diagrams of a DMM frame and a DMR frame which are used by the NMS to perform the group measurement method in accordance with the present invention;

FIGS. 8A-8E are diagrams associated with an exemplary IPTV network which are used to help explain one embodiment of the present invention; and

FIGS. 9A-9J are diagrams associated with an exemplary IPTV network which are used to help explain another embodiment of the present invention.

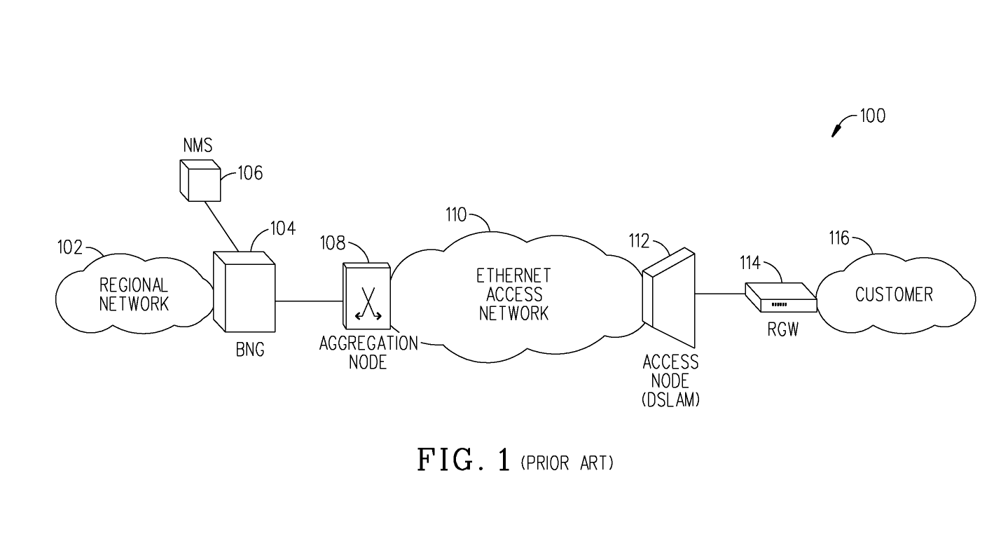

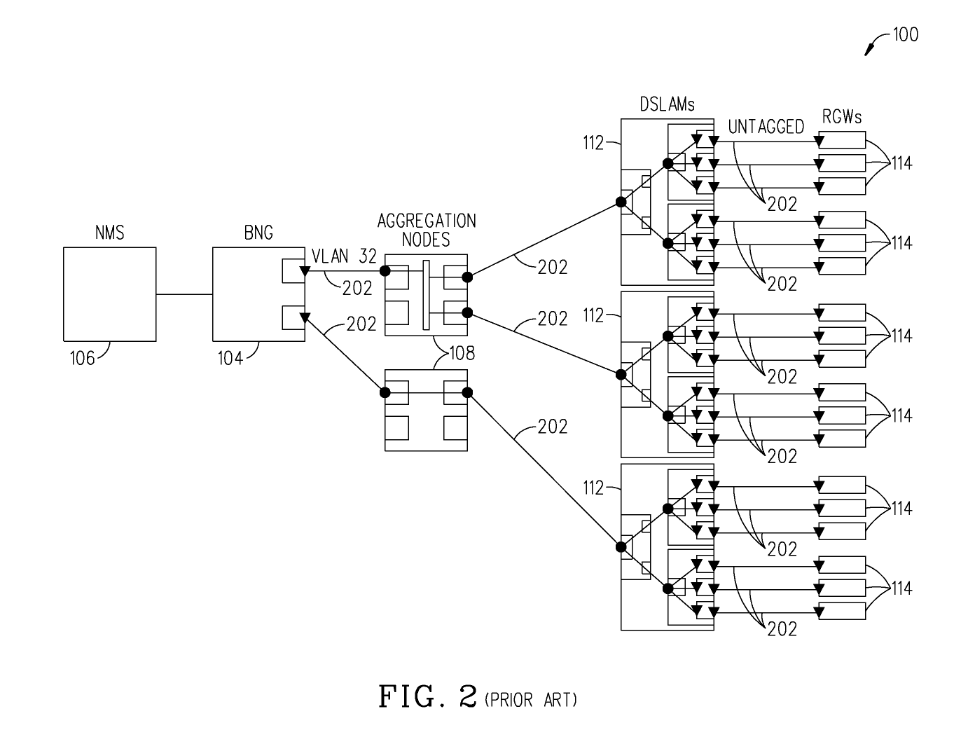

### DETAILED DESCRIPTION

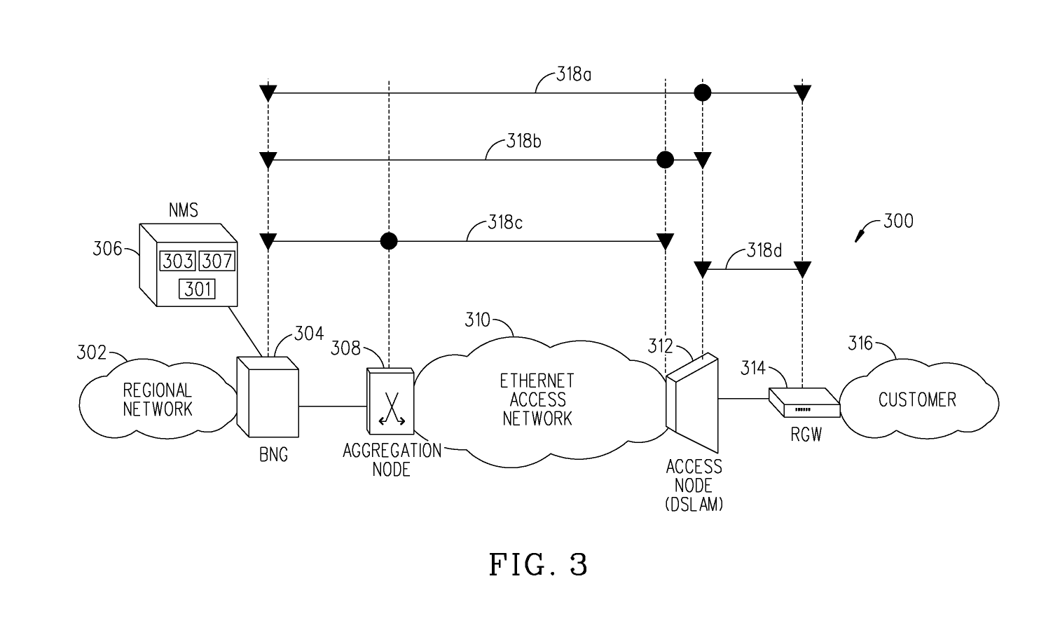

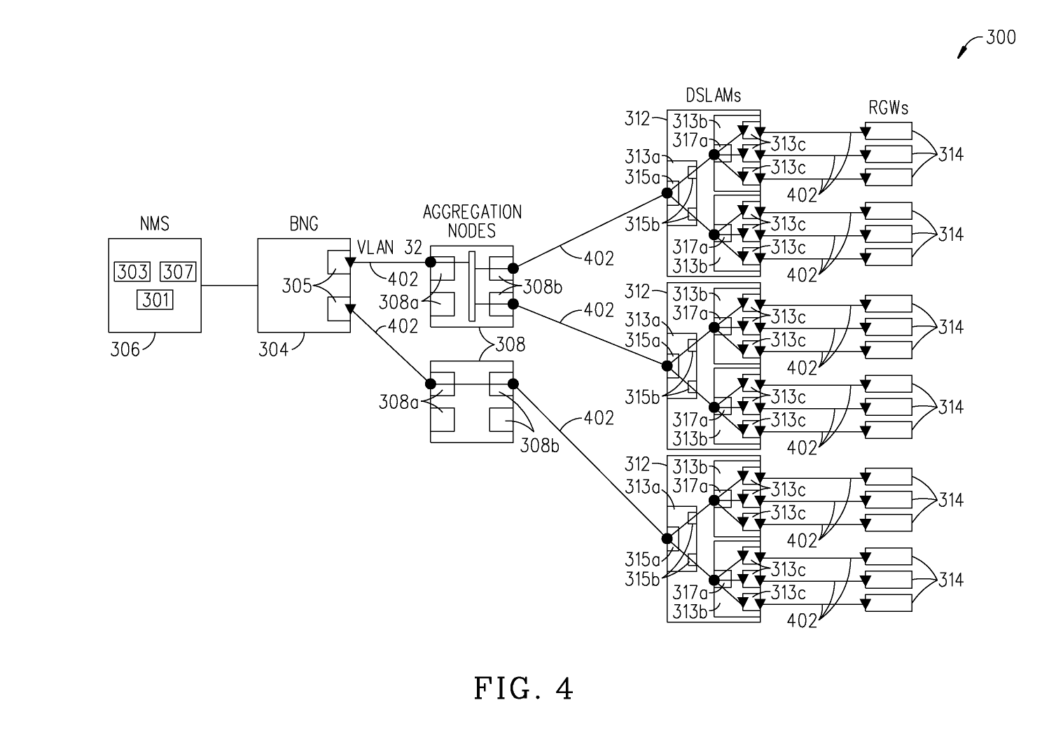

Referring to FIGS. 3-4, there are two block diagrams of an IPTV network 300 (with an Ethernet-based DSL aggregation) which has a NMS 306 that implements a group delay measurement method 301 in accordance with the present invention (note: the present invention functions as well in an IPTV network based on a PON model in which the DSLAM is replaced by an OLT and ONT). As shown, the IPTV network 300 includes a regional network 302 which is coupled to a BNG 304 (with ports 305) which is coupled to an aggregation node 308 (with input ports 308a and output ports 308b). The NMS 306 (with a processor 303 and a memory 307) is coupled to the BNG 304. The aggregation node 308 is connected by an Ethernet access network 310 to multiple access nodes 312 (e.g., DSLAMs 312 each of which include a NT card 313a which has NT exterior-facing ports 315a and NT interior-facing ports 315b and a LT card 313b which has LT interior-facing ports 317a and LT exterior facing ports 313c). The DSLAMs 312 are respectively connected to multiple RGWs 314 which are in turn respectively associated with multiple customers 316.

In this IPTV network 300, all BTV traffic (multiple TV channels) at the Ethernet level (level 2) use the same VLAN (e.g., VLAN 32 shown in FIG. 4) in which a multicast stream 402 corresponds to a TV channel (e.g., CNN or Eurosport). The customer 316 is a “listener” if he/she has joined a particular multicast stream 402 by selecting the corresponding TV channel on a set-top box associated with their TV. Plus, all of the nodes/ports between the BNG 304 and the customer 316 would also be a “listener” of the particular multicast stream 402 (note 1: a “listener” is a L3 concept (i.e. IP layer) while at L2 (i.e. Ethernet) an IP-unaware device will just broadcast multicast traffic and if there is an IP-aware device then it will typically use IGMP snooping to propagate data downstream as if it were an actual L3 listener). For example, the RGW 314 can become a “listener” and join a multicast group to receive the particular multicast stream 402 by using IGMP (or MLD). Likewise, the DSLAM 312 could become a “listener” and join the multicast group by performing IGMP proxying.

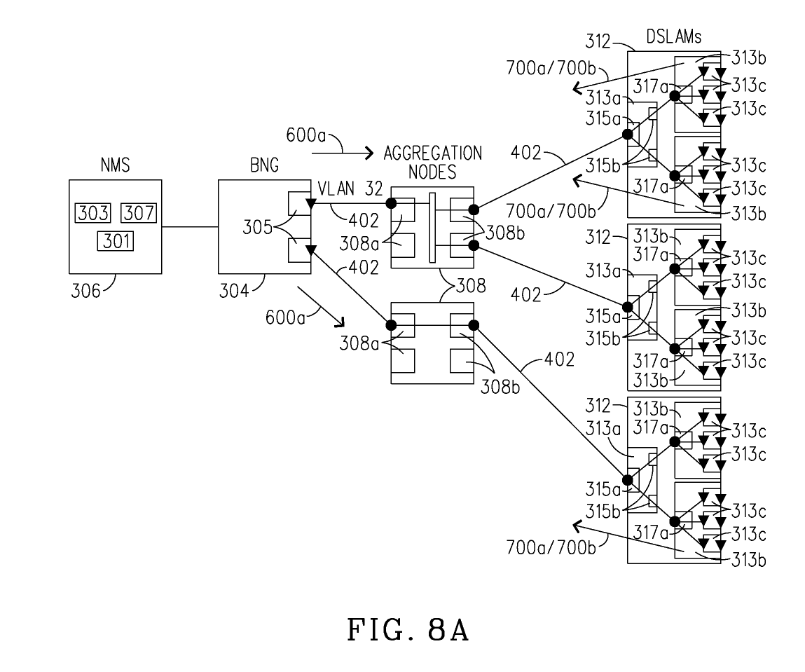

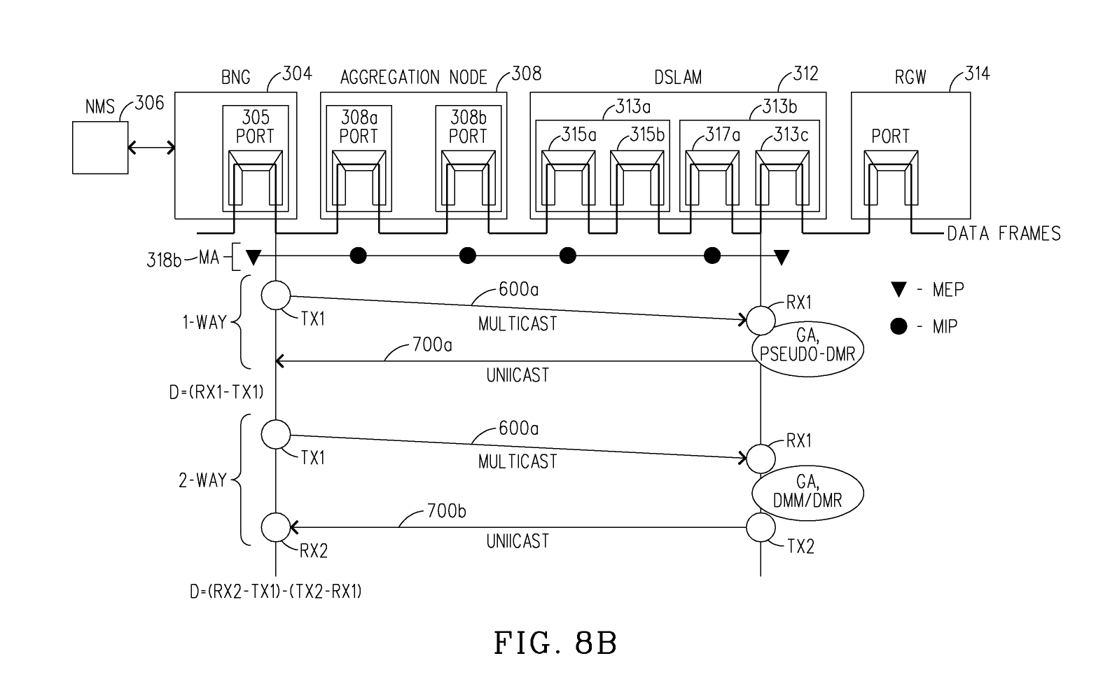

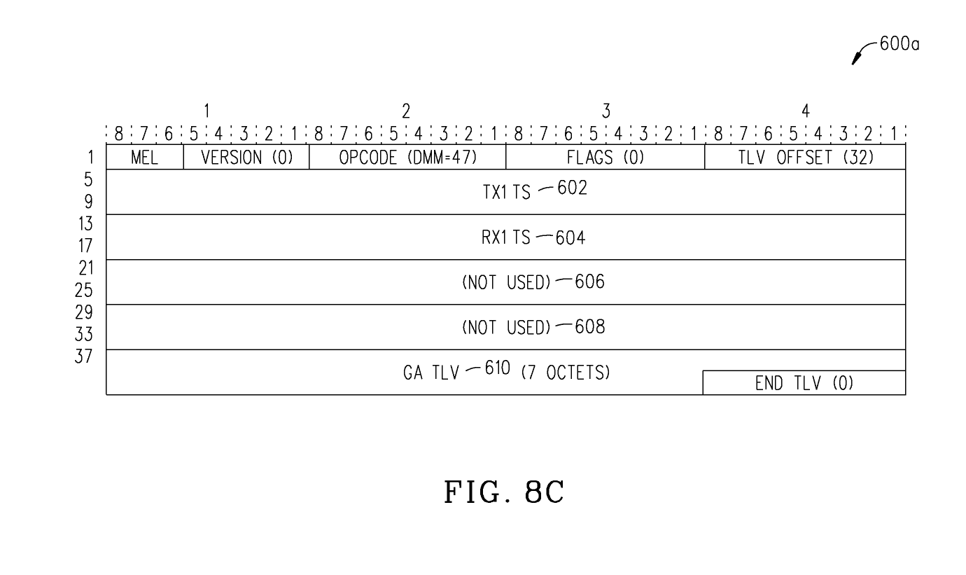

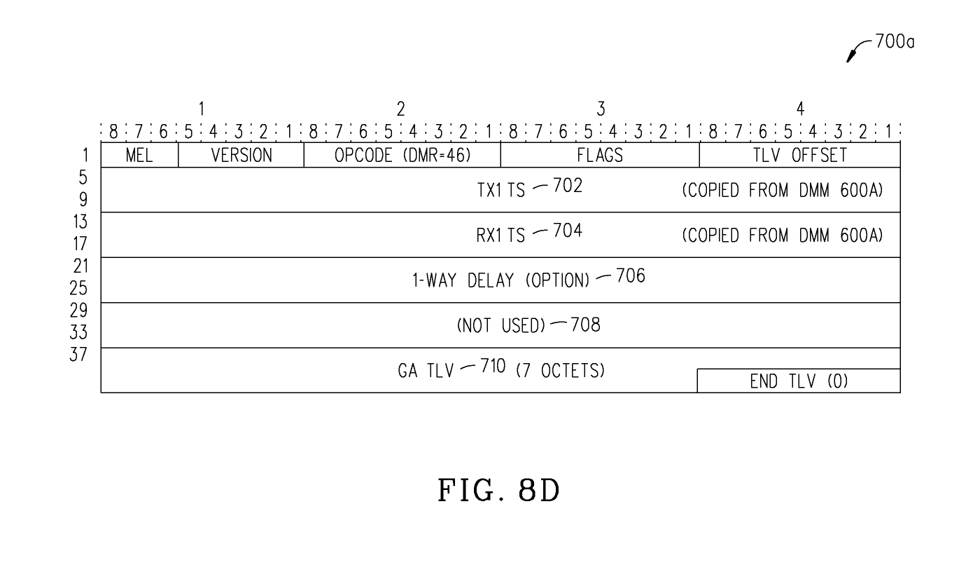

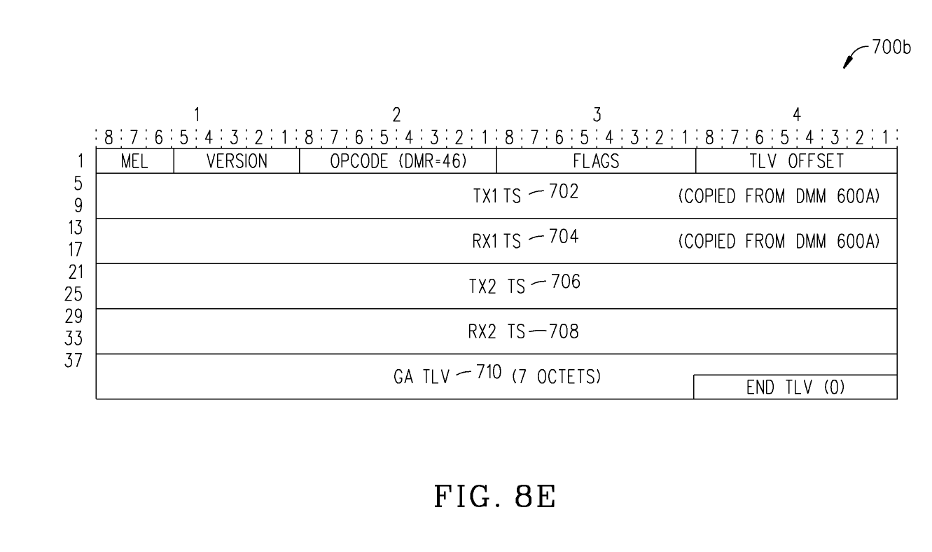

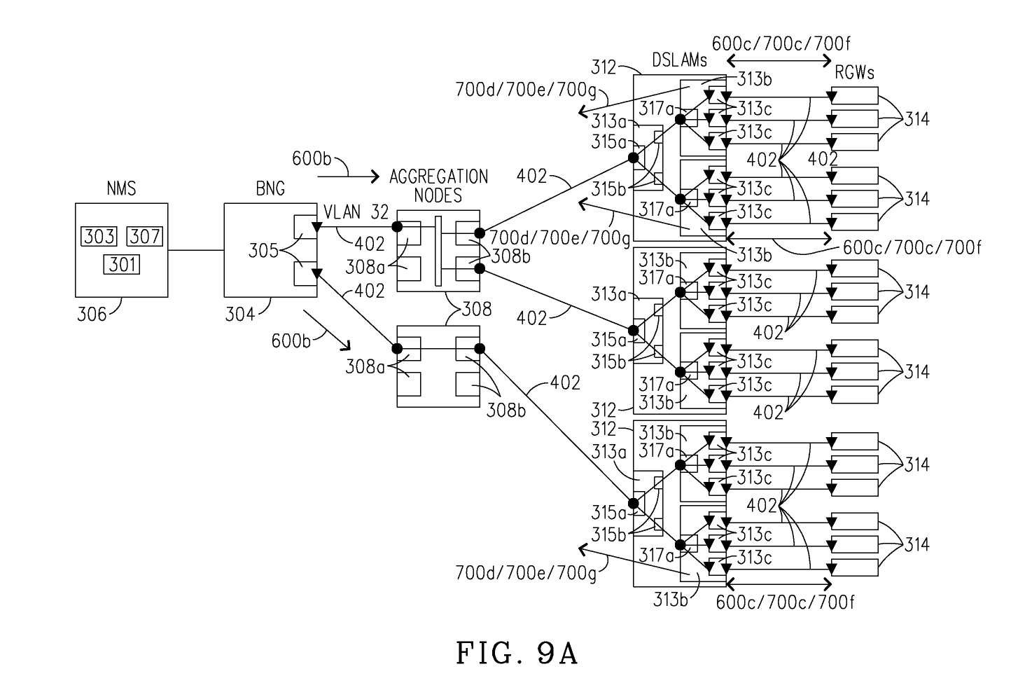

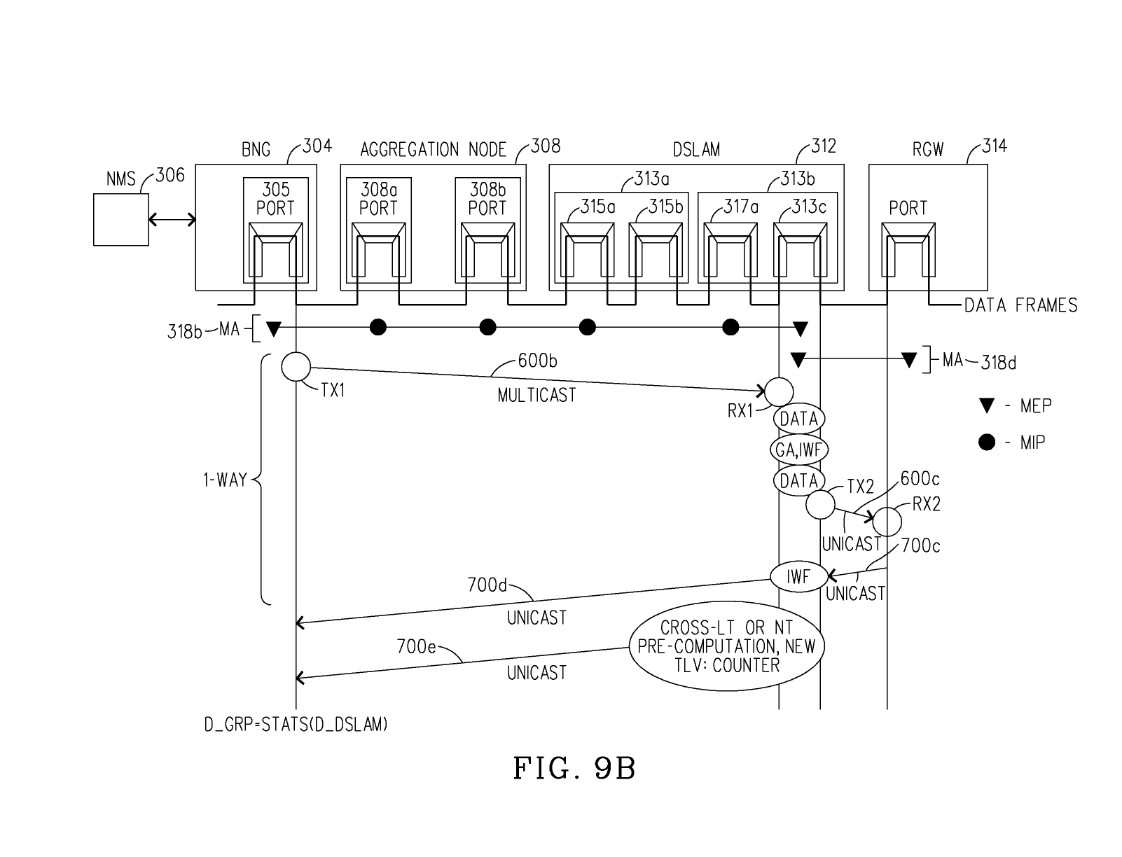

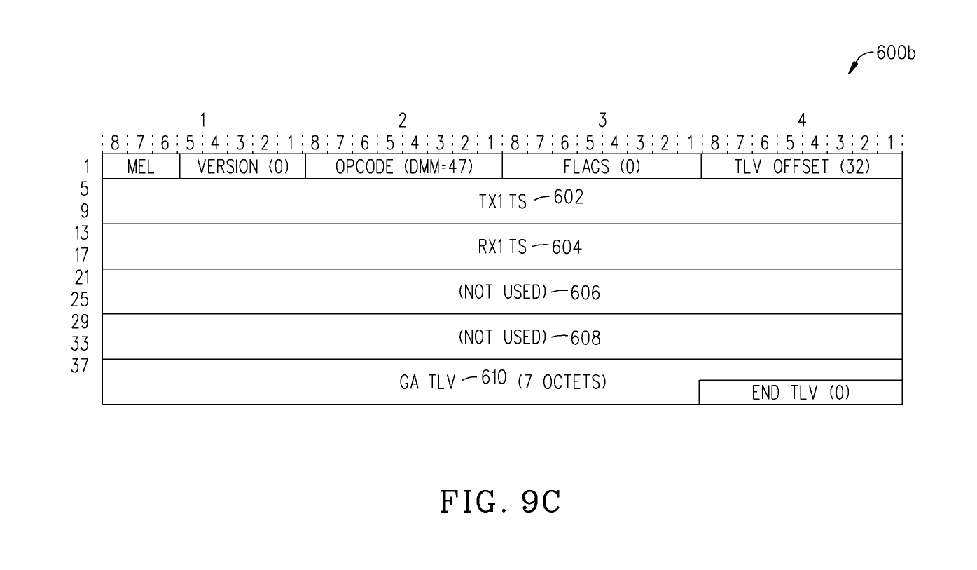

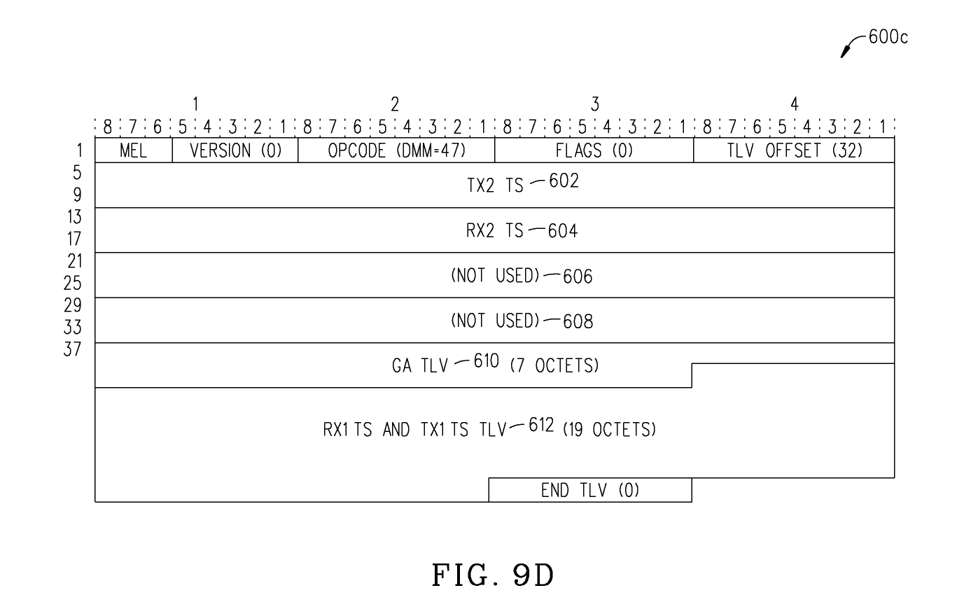

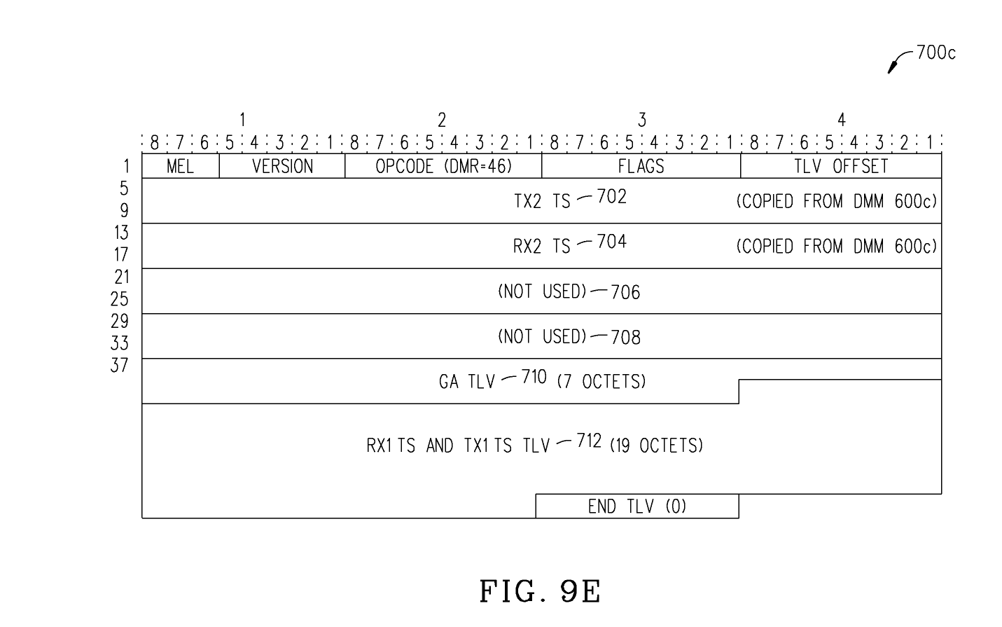

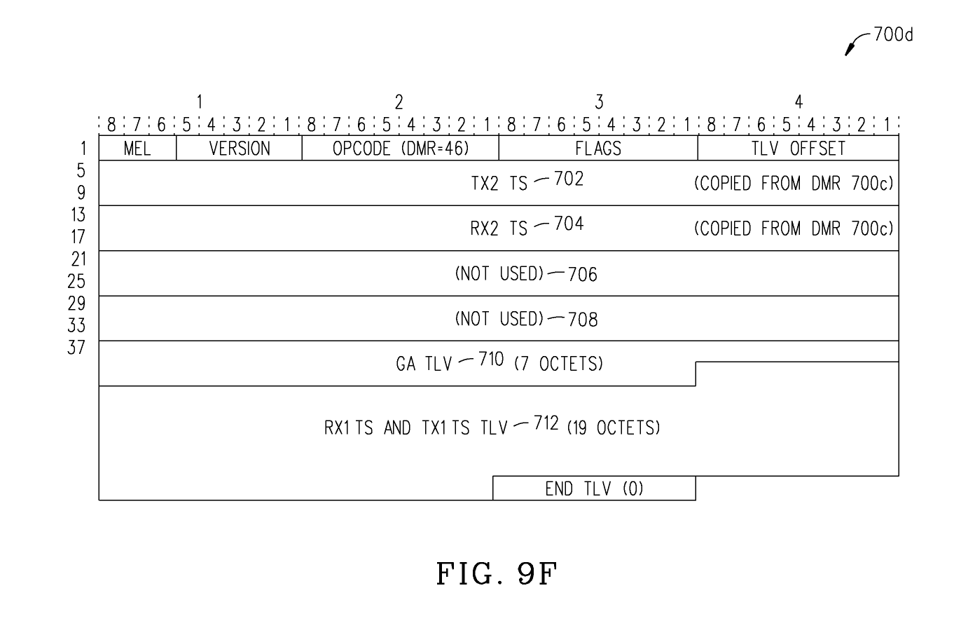

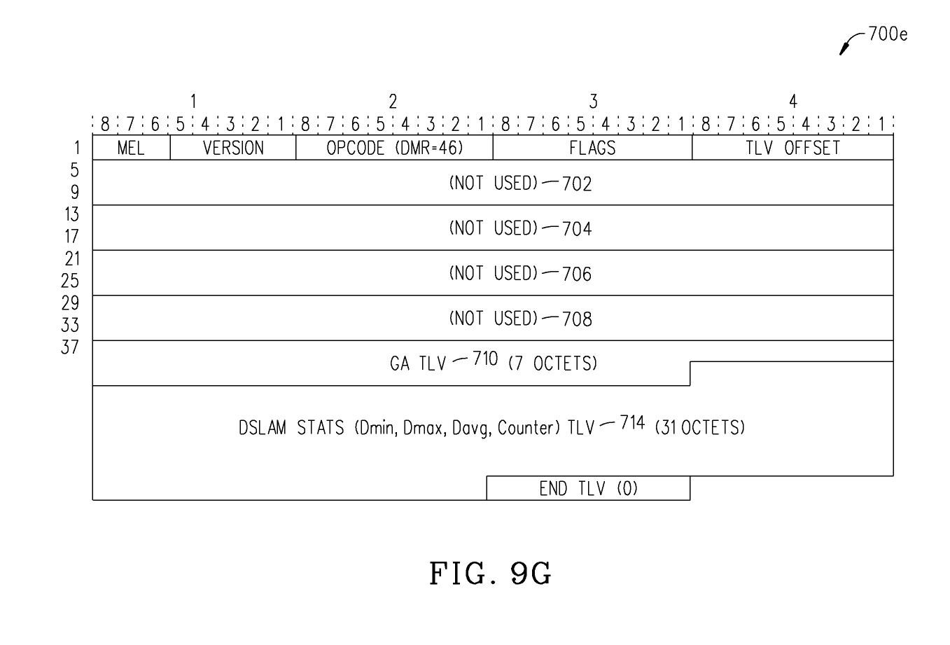

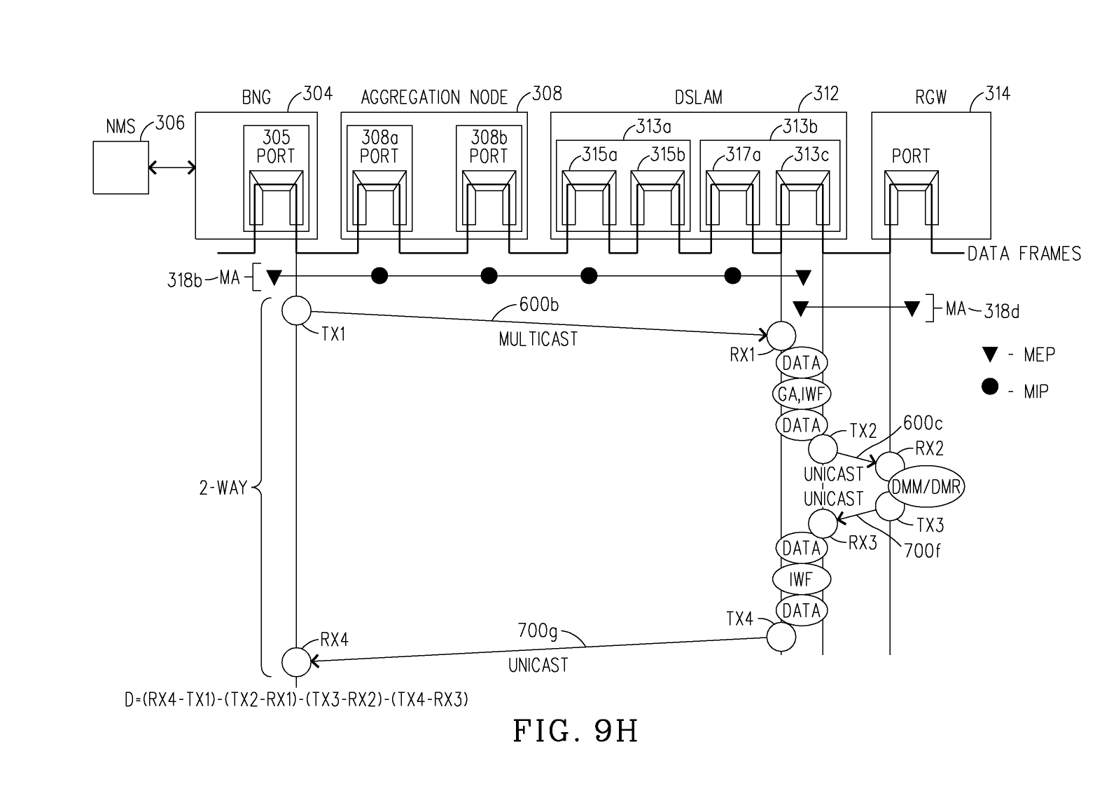

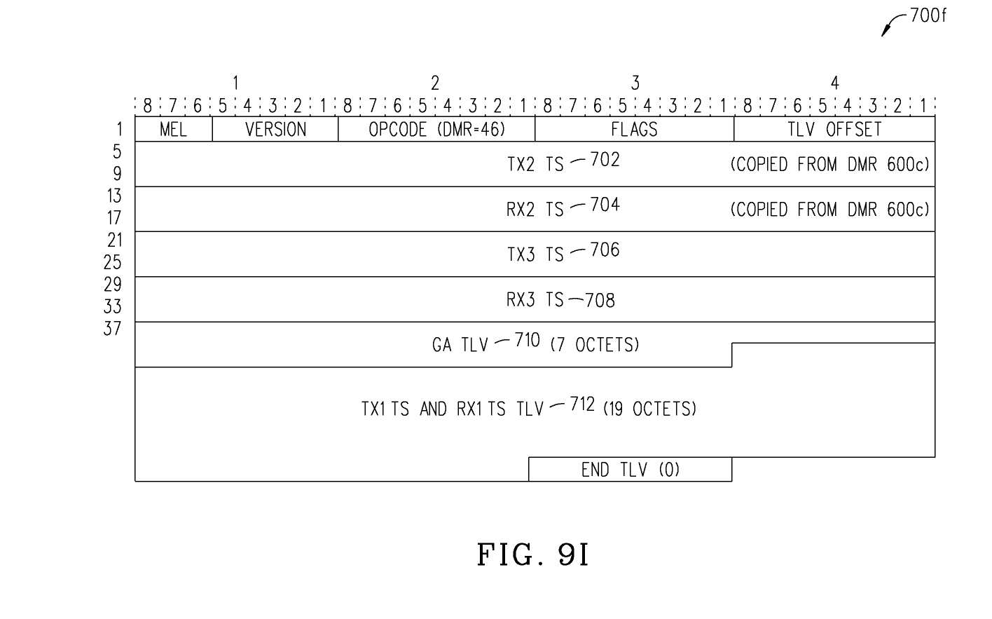

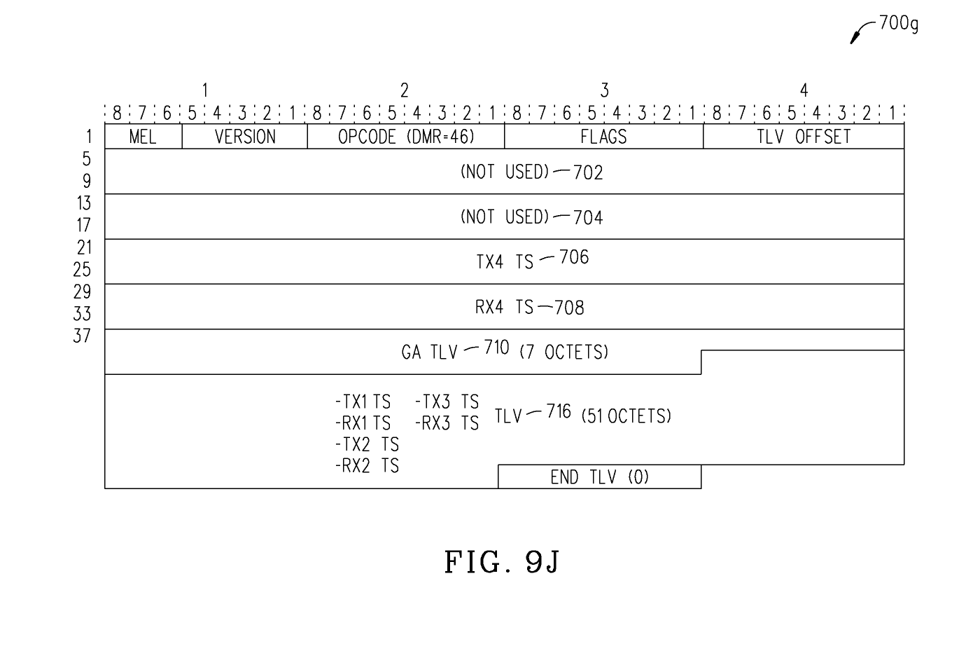

A basic idea of the group delay measurement method 301 uses an upgraded Ethernet OAM (based on IEEE 802.1ag (dated Feb. 8, 2007) and in particular ITU-T Y-1731 (dated May 2006)—the contents of which are incorporated by reference herein) to measure the Delay (which is used to calculate the Delay Variation) for the group of listeners to a particular multicast stream 402 (TV channel). It is well known that the Ethernet OAM supports MAs and four exemplary MAs 318a, 318b, 318c and 318d have been illustrated in FIG. 3 (note: MAs 318b and 318b are of particular interest for this exemplary multicast BTV performance group measurement method 301). Plus, the current Ethernet OAM and in particular the ITU-T Y-1731 has defined a point-to-point D/DV measurement method between two MEPs of a single MA (see MEPs in FIG. 3). In addition, the current Ethernet OAM and in particular the ITU-T Y-1731 supports three special OAM frames, namely the 1DM (1-way Delay Measurement), the DMM (for 2-way Delay Measurement Message) and the DMR (for Delay Measurement Response). In one embodiment of the present invention, the method 301 enhances the DMM/DMR frame formats to have useful TLVs, especially one containing the multicast address of the TV channel, so that it is possible to distinguish which MEPs are listeners to the particular TV channel 402 (e.g., CNN) within the shared VLAN (e.g., VLAN 32). Plus, the method 301 can use a number of different new utility TLVs which contain intermediate delay aggregates, counters, etc . . . as will be discussed in detail below with respect to FIGS. 8 and 9.

These enhanced DMM/DMR messages can be originated from any node with a MEP participating in the MA associated to the BTV VLAN. Typically, the chosen originating MEP will be a node like the BNG 304, i.e. the MEP closest to the multicast source in the IPTV network 300, and the propagation will be downstream, towards the listeners (DSLAMs 312 or even the RGWs 314). Basically, the NMS 306 instructs the originating node (e.g., BNG 304) to send the first probe (an enhanced multicast DMM, even for one-way Delay measurements) which follows closely the actual datapath of multicast traffic 402 in the same VLAN, for better accuracy (see FIGS. 8B, 9B and 9H). For further scalability, only listeners (DSLAMs 312 and if desired the RGWs 314) of this multicast channel 402 will react to this probe by sending an enhanced DMR response back for 1-way delays or 2-way delays (this is discussed in greater detail below). The listeners in sending this response use a unicast DMR message which could possibly cause a potential scalability issue where the originating node (BNG 304) receives too many unicast DMR messages. Generally, the load of the DMR responses at the originating node (BNG 304) should be considered acceptable since the proposed diagnostic tool/method 301 is on-demand. However, if the DMR response load is not considered acceptable, then the listener MEPs can utilize an optional randomized latency delay mechanism for controlling the transmission of the DMR responses to avoid too many simultaneous DMR responses being sent back to the originating node (BNG 304). As will be appreciated after the detailed discussion below, the BNG 304 also has a load that is already somewhat distributed among multiple ports 305 where each of these ports 305 send a multicast DMM and subsequently receive the corresponding unicast DMRs.

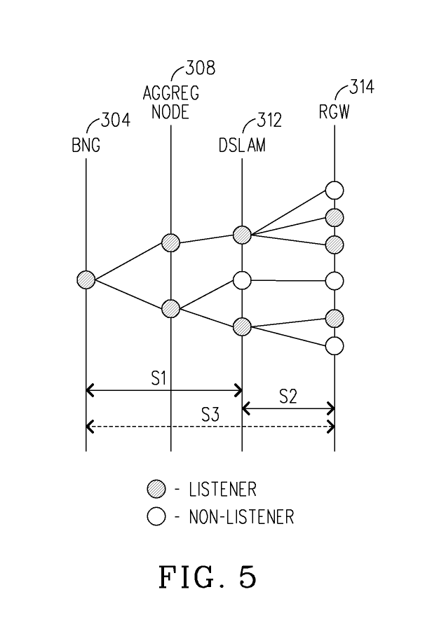

The exemplary IPTV network 300 which is described herein has a multicast tree in which the PIM tree is stopped at the BNG 304. However, the interesting part of the IPTV network 300 is downstream of the BNG 304, since this is where membership to the multicast stream 402 is the most dynamic and delays are the most likely to vary. In fact, the method 301 if desired can be used to measure the D/DV (Delay/Delay Variation) for a group of listeners of a particular BTV multicast stream 402 for different scopes S1-S3, each of which may have a particular interest from an operational point of view (see FIG. 5 and note scope S2 is a collection of independent point-to-point measurements which can be made by using the state-of-the-art tools so in this case there is no need to implement method 301):
Scope S1: BNG 304 to DSLAM 312
Scope S2: DSLAM 312 to RGW 314
Scope S3: BNG 304 to RGW 314

Following is a detailed discussion about the group delay measurement method 301 and the DMM/DMR frame formats for scopes S1 and S3. Scope S1 alone may be enough for some providers, while scope S3 provides more insight but is more complex and requires the use of IWFs in the DSLAM 312. Again, scope S2 is in fact a collection of independent point-to-point measurements, so in this situation there is no need to use the group measurement method 301. Note: only the group delay measurement is discussed below since the Delay Variation is a statistic (based on Delay) that can be computed afterwards, and therefore does not require the use of a special group delay variation measurement method 301.

Scope S1: from BNG 304 to DSLAM 312

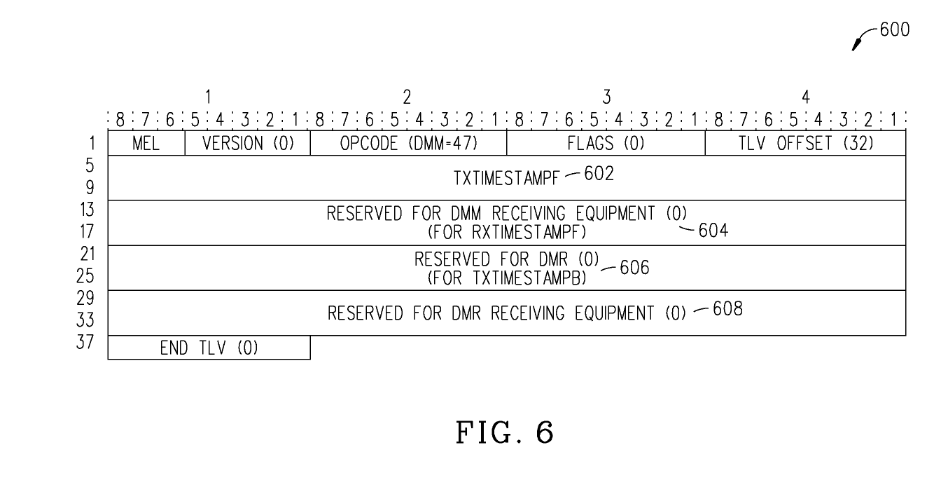

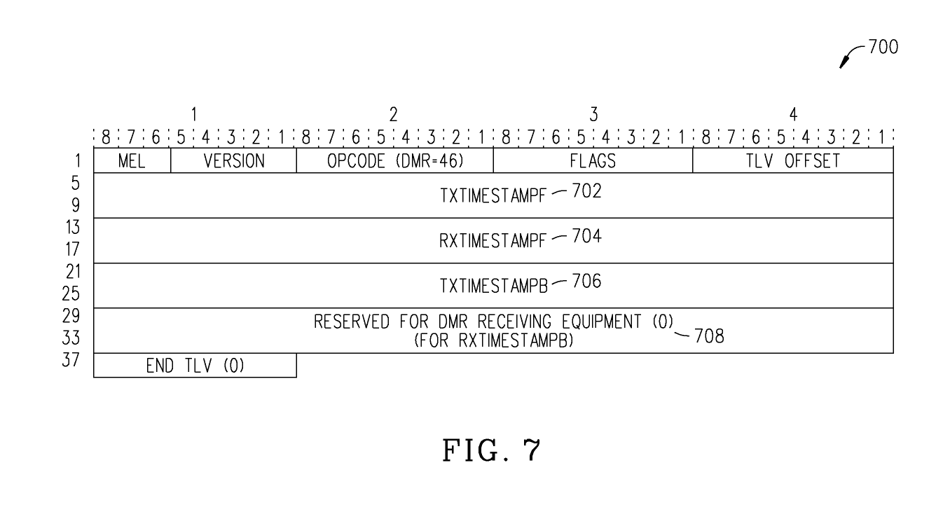

In this case, the method 301 uses DMM/DMR frames with a multicast DA class 1 so they can reach all of the MEPs associated with MA 318b (see FIG. 3) (note: class 1 is a Y.1731 concept and is not defined in IEEE 802.1ag). FIG. 6 illustrates the format of the basic DMM frame 600 (OpCode 47) which has a header with: (1) sender Tx TS (Time Stamp) 602; (2) placeholder for receiver Rx TS 604; (3) placeholder for receiver Tx TS 606; and (4) placeholder for sender Rx TS 608. And, FIG. 7 illustrates the format of the basic DMR frame 700 (OpCode 46) which has a header with: (1) sender Tx TS 702; (2) receiver Rx TS 704; (3) receiver Tx TS 706; and (4) placeholder for sender Rx TS 708. Because the DMM 600 and DMR 700 each have 4 timestamp placeholders in their headers (not TLVs), this enables a faster hardware implementation, and better group measurement accuracy (wiretime TS).

Referring to FIGS. 8A-8E, the NMS 306 causes a DMM 600a (which has a GA added to a TLV 610 in accordance with the present invention) to be sent/multicast only once from each port 305 with a BTV MEP in the BNG 304 (see FIGS. 8A-8C). And, in accordance with the present invention either a 1-way Delay or a 2-way Delay can be measured as follows:

### 1-Way Delay:

1. BNG 304 sends a multicast DMM frame 600a with a sending TX1 TS (in DMM header sender Tx TS 602) and a GA TLV 610 which contains the multicast address (Ethernet or IP multicast address) of a TV channel 402 (see FIG. 8C) (note: the Ethernet multicast address can be derived from the IP multicast address (there is a special reserved MAC address range reserved in Ethernet for mapping IP multicast addresses)).

2. DSLAM LT port 313c receives DMM frame 600a and looks at its clock to obtain Receiver RX1 TS and writes the RX1 TS in DMM header 604 (see FIG. 8C).

3. If the DSLAM LT port 313c is a listener of this GA, then it sends back unicast DMR 700a which has: (1) the TX1 TS (in DMR header sender Tx TS 702); (2) the RX1 TS (in DMR header receiver Rx TS 704); and (3) the GA in TLV 710 (see FIG. 8D). Note: the DSLAM LT port 313c ignores the DMM 600a if it is not a listener and thanks to the GA TLV the DSLAM 312 can inspect their FDB table to determine whether this DSL port 313c is a listener or not. Option: if desired a pre-computed 1-way Delay value can be overwritten in DMR TS header receiver Tx TS 706 (as shown) or it can be added to the DMR 700a as an optional TLV (not shown). Plus, the DSLAM LT port 313c may implement a randomized response delay mechanism to avoid simultaneous arrivals of DMRs 700a at the BNG 304. This may be used because for each sent multicast DMM 600a, the BNG 304 may receive many unicast DMRs 700a from the DSLAM LT ports 313c who are listeners. Finally, the BNG 304 may archive each measurement for the NMS 306, or it could do some local pre-computation before sending a group delay summary (e.g., Dmin, Dmax, DVmin-to-max and Davg) to the NMS 306 (note: an example formula for the Davg could be

$${D}_{avg} = \frac{{\sum }_{i = 1}^{n} {D}_{i}}{n} ,$$

i.e. the arithmetic average of the n measured one-way delays Di, each Di being equal to its respective (RX1_TS−TX1_TS).

4. Alternatively, each DSLAM LT port 313c can send its DMR 700a data directly to the NMS 306, or hold it for later retrieval. In these cases, the DSLAM 313 would not send DMRs 700a back to the BNG 304.

### 2-Way Delay:

1. BNG 304 sends a multicast DMM frame 600a with a sending TX1 TS (in DMM header sender Tx TS 602) and a GA TLV 610 which contains the multicast address (Ethernet or IP multicast address) of a TV channel 402 (see FIG. 8C).

2. DSLAM LT port 313c receives DMM frame 600a and looks at its clock to obtain Receiver RX1 TS and writes the RX1 TS in DMM header 604 (see FIG. 8C).

3. If the DSLAM LT port 313c is a listener of this GA, then it sends back unicast DMR 700b which has: (1) the TX1 TS (in DMR header sender Tx TS 702); (2) the RX1 TS (in DMR header receiver Rx TS 704); (3) the TX2 TS (in DMR header receiver Tx TS 706 (note: this is the time when the DMR 700b is sent from the DSLAM LT port 313c); and (4) the GA in TLV 710 (see FIG. 8E). Note: the DSLAM LT port 313c ignores the DMM 600a if it is not a listener and thanks to the GA TLV, the receiver can inspect their FDB table to determine whether this DSLAM LT port 313c is a listener or not. If desired, the DSLAM LT port 313c may implement a randomized response delay mechanism to avoid simultaneous arrivals of DMRs 700b at the BNG 304. This may be used because for each sent multicast DMM 600a, the BNG 304 may receive many unicast DMRs 700b from the DSLAM LT ports 313c who are listeners.

4. For each received unicast DMR 700b, the BNG 304 looks at its clock to obtain Receiver RX2 TS and writes the RX2 TS in the placeholder for sender Rx TS 708 (see FIG. 8E). The BNG 304 may archive each measurement for the NMS 306. Or, the BNG 304 could do some local pre-computation before sending a group delay summary (e.g., Dmin, Dmax, DVmin-to-max and Davg) to the NMS 306 (note: an example formula for the Davg could be

$${D}_{avg} = \frac{{\sum }_{i = 1}^{n} {D}_{i}}{n} ,$$

i.e. the arithmetic average of the n measured two-way delays Di, each Di being equal to its respective (RX2_TS−TX1_TS)−(TX2_TS−RX1_TS)=(RX1_TS−TX1_TS)+(RX2_TS−TX2_TS).
Note 1: The 1-way delay and the 2-way delay can be calculated by analyzing the various time stamps in the DMRs 700a and 700b.
Note 2: The 1-way Delay measurement assumes the clocks are reasonably well synchronized, i.e. the clocks in BNG 304 and DSLAM 312 are permanently adjusted by some other mechanism so that they always give the same time.
Note 3: A benefit of this 1-way and 2-way group measurement scheme is that the D/DV is measured only for the TV channel 402 and not for the whole BTV VLAN. Plus, the 1-way and 2-way group measurement method 301 also minimizes the number of DMR 700a and 700b replies to the BNG 304.
Note 4: If a node (DSLAM 312) collects the aforementioned time stamps in software, then the method 301 by using Ethernet OAM will provide better accuracy than IP software, since L2 OAM software is closer to the wiretime than is L3. In addition, if a node has hardware-assists dedicated to ITU-T Y.1731 DMM/DMR time stamps, then the method 301 can take advantage of these even more accurate time stamps.
Scope S3: from BNG 304 to RGW 314

Referring to FIGS. 9A-9J, the NMS 306 causes a DMM 600b (which has a GA added to a TLV 610 in accordance with the present invention) to be sent/multicast only once from each port 305 with a BTV MEP in the BNG 304 (see FIGS. 9A-9C). Then, either a 1-way Delay or a 2-way Delay can be measured as follows:

### 1-Way Delay:

1. BNG 304 sends a multicast DMM frame 600b (for MA 318b) with a sending TX1 TS (in DMM header sender Tx TS 602) and a GA TLV 610 which contains the multicast address (Ethernet or IP multicast address) of a TV channel 402 (see FIG. 9C) (note: the Ethernet multicast address can be derived from the IP multicast address (there is a special reserved MAC address range reserved in Ethernet for mapping IP multicast addresses)).

2. DSLAM LT port 313c receives DMM frame 600b and looks at its clock to obtain Receiver RX1 TS and writes the RX1 TS in DMM header 604 (see FIG. 9C).

3. If the DSLAM LT port 313c is a listener of this GA, then it and in particular a MEP (associated with MA 318b) executes an IWF to change from the MEP (associated with MA 318b) to another MEP (associated with MA 318d) (see FIG. 9B). Also during the execution of this IWF, the DMM frame 600b is revised to DMM frame 600c in which the TX1 TS and RX1 TS are saved in TLV 612 (see FIG. 9D). Then, the DSLAM LT port 313c adds TX2 TS (in DMM header sender Tx TS 602) and sends the DMM frame 600c to the respective RGW 314 (see FIGS. 9A-9B).

4. RGW 314 receives DMM frame 600c and looks at its clock to obtain Receiver RX2 TS and writes the RX2 TS in DMM header 604 (see FIG. 9D). As can be seen, the four relevant TSs (TX1, RX1, TX2 and RX2) have now been collected. At this point, the RGW 314 can stop the process and send the time data directly to the NMS 306 or hold the data for later retrieval. Or, the RGW 314 (and possibly a randomized response delay mechanism) can send the data back to the BNG 304. This last scenario is what is described in detail next.

5. RGW 314 sends back unicast DMR 700c which has: (1) the TX2 TS (in DMR header sender Tx TS 702); (2) the RX2 TS (in DMR header receiver Rx TS 704); (3) the GA (in DMR TLV 710); and (4) the TX1 TS and RX1 TS (in DMR TLV 712) (see FIG. 9E).

6. The DSLAM LT port 313c receives the DMR 700c and the MEP (associated with MA 318d) executes an IWF to change from the MEP (associated with MA 318d) to another MEP (associated with MA 318b) (see FIG. 9B). Also during the execution of this IWF, the MEP 318d revises the DMR frame 700c to the revised DMR 700d (see FIG. 9F where the DMR 700d has the same TSs and TLVs as DMR 700c).

7. The DSLAM LT port 313c (MEP 318b) can forward the unicast DMR 700d to the BNG 304 (see FIG. 9F). Or, the DSLAM LT 313b can perform some pre-computation and wait to compile all of the unicast DMRs 700c received from all of the RGWs 314. And, then the DSLAM LT 313b would send a single unicast DMR 700e to the BNG 304 (see FIG. 9G). For instance, the pre-computation in a DSLAM(j) would result in the determination of the following parameters Dmin(j), Dmax(j), DVmin-to-max(j) and Davg(j) where an example formula for the Davg(j) could be

$${D}_{avg} ( j ) = \frac{{\sum }_{i = 1}^{{C}_{j}} {D}_{i}}{{C}_{j}} ,$$

i.e. the arithmetic average of the Cj measured one-way delays Di, each Di being equal to its respective (RX2_TS−TX1_TS)−(TX2_TS−RX1_TS)=(RX1_TS−TX1_TS)+(RX2_TS−TX2_TS). Each replying DSLAM(j) has at least one measured delay Di, and the total number of delays Di is denoted Cj. These values Dmin(j), Dmax(j), DVmin-to-max(j) and Davg(j), plus the Counter Cj (number of compiled LT port 313c DMRs 700c) would be placed in TLV 714 of the resulting unicast DMR 700e (see FIG. 9G).

8. The BNG 304 for each sent DMM 600b is going to receive either one DMR 700d from each DSLAM listener LT port 313c. Or, the BNG 304 is going to receive one compiled DMR 700e (with pre-computed data and a counter of LT ports 313c) from each listener DSLAM 312, from which the BNG can compute the global average using the example formula

$${D}_{avg} = \frac{{\sum }_{j = 1}^{m} {C}_{j} {D}_{avg} ( j )}{{\sum }_{j = 1}^{m} {C}_{j}}$$

i.e. the weighted average of the m locally pre-computed Delay averages Davg(j), sent by each replying DSLAM(j).

### 2-Way Delay:

1. BNG 304 sends a multicast DMM frame 600b (for MA 318b) with a sending TX1 TS (in DMM header sender Tx TS 602) and a GA TLV 610 which contains the multicast address (Ethernet or IP multicast address) of a TV channel 402 (see FIG. 9C).

2. DSLAM LT port 313c receives DMM frame 600b and looks at its clock to obtain Receiver RX1 TS and writes the RX1 TS in DMM header 604 (see FIG. 9C).

3. If the DSLAM LT port 313c is a listener of this GA, then it and in particular a MEP (associated with MA 318b) executes an IWF to change from the MEP (associated with MA 318b) to another MEP (associated with MA 318d) (see FIG. 9H). Also during the execution of this IWF, the DMM frame 600b is revised to DMM frame 600c in which the TX1 TS and RX1 TS are saved in TLV 612 (see FIG. 9D). Then, the DSLAM LT port 313c adds TX2 TS (in DMM header sender Tx TS 602) and sends the DMM frame 600c to the respective RGW 314 (see FIGS. 9A and 9H).

4. RGW 314 receives DMM frame 600c and looks at its clock to obtain Receiver RX2 TS and writes the RX2 TS in DMM header 604 (see FIG. 9D).

5. RGW 314 looks at its clock to obtain TX3 TS and then sends an unicast DMR 700f which has: (1) the TX2 TS (in DMR header sender Tx TS 702); (2) the RX2 TS (in DMR header receiver Rx TS 704); (3) the TX3 TS (in DMR header receiver Tx TS 706; (4) the GA (in DMR TLV 710); and (5) the TX1 TS and RX1 TS (in DMR TLV 712) (see FIG. 9I).

6. The DSLAM LT port 313c receives the DMR 700f and looks at its clock to obtain RX3 TS (which is placed in DMR header placeholder for sender Rx TS 708) (see FIG. 9I). Then, the MEP (associated with MA 318d) executes an IWF to change from the MEP (associated with MA 318d) to another MEP (associated with MA 318b) (see FIG. 9H). Also during the execution of this IWF, the MEP 318d revises the DMR frame 700f to DMR frame 700g, collects TX4 and stores it in DMR header 706 of DMR frame 700g, and forwards the revised DMR 700g to BNG 304 (see FIG. 9J and note the specific frame format is discussed in detail in the next step).

7. For each received unicast DMR 700g, the BNG 304 looks at its clock to obtain Receiver RX4 TS and writes the RX4 TS in the placeholder for sender Rx TS 708 (see FIG. 9J). At this point the DMR 700g has: (1) the TX4 TS (in DMR header receiver Tx TS 706); (2) the RX4 TS (in DMR header placeholder for sender Rx TS 708); (3) the GA (in DMR TLV 710); and (4) the TX1 TS, RX1 TS, TX2 TS, RX2 TS, TX3 TS and RX3 TS (in DMR TLV 716) (see FIG. 9J and note the DMR headers sender Tx TS 702 and receiver Rx TS 704 are not used).

8. The BNG 304 may archive each time measurement for the NMS 306, or it could do some local pre-computation before sending a group delay summary (e.g., Dmin, Dmax, DVmin-to-max and Davg) to the NMS 306 (note: an example formula for the Davg could be

$${D}_{avg} = \frac{{\sum }_{i = 1}^{n} {D}_{i}}{n} ,$$

where each Di (one for each listener RGW) can be computed as

$${D}_{i} = {\sum }_{i = 1}^{4} ( R {x}_{i} - T {x}_{i} ) = ( R {x}_{4} - T {x}_{1} ) - {\sum }_{i = 1}^{3} ( T {x}_{i + 1} - R {x}_{i} ) .$$

Note 1: The 1-way delay and the 2-way delay can be calculated by analyzing the various time stamps in the DMRs 700d, 700e and 700g.
Note 2: The 1-way Delay measurement assumes the clocks are reasonably well synchronized, i.e. the clocks in BNG 304, DSLAM 312, and RGW 314 are permanently adjusted by some other mechanism so that they always give the same time.
Note 3: A benefit of this 1-way and 2-way group measurement scheme is that the D/DV is measured only for the TV channel 402 and not for the whole BTV VLAN. Plus, the 1-way and 2-way group measurement method 301 also minimizes the number of DMR 700d, 700e and 700g replies to the BNG 304.
Note 4: If a node (DSLAM 312) collects the aforementioned time stamps in software, then the method 301 by using Ethernet OAM will provide better accuracy than IP software, since L2 OAM software is closer to the wiretime than is L3. In addition, if a node has hardware-assists dedicated to ITU-T Y.1731 DMM/DMR time stamps, then the method 301 can take advantage of these even more accurate time stamps.

From the foregoing, it can be readily appreciated by those skilled in the art that the present invention provides an NMS 306 which has a processor 303 which accesses instructions from a memory 307 and processes those instructions to: (1) instruct an originating node (e.g., BNG 304) to send a layer 2 multicast message (e.g., Ethernet OAM DMM frame) with a first transmit time and a multicast address of the multicast stream towards a plurality of destination nodes (e.g., DSLAMs 312 or RGWs 314 depending on scope S1 or scope S3); and (2) cause each of the destination nodes that are listeners of the multicast stream to transmit a layer 2 unicast message (e.g., Ethernet OAM DMR frame) which includes the first transmit time, the multicast address of the multicast stream and additional timing information which are used to measure a delay in the multicast stream for a group of listeners. The measured Delay of the application data (video) in this case where it is measured on the Ethernet layer is expected to be similar to D_{video}≈D_{IP}≈D_{Ethernet} (note: the Ethernet delay would actually be more accurate than IP delay (measured on the IP layer) since the Ethernet layer is closer to the ideal “wire time” even without the aid of hardware time stamps). However, the measured DV should be interpreted more carefully because one video I-frame for instance can be fragmented in several IP packets, which can each be fragmented in several Ethernet frames. Plus, several smaller B-frames or P-frames may be grouped in a single IP packet. Thus, the DV definition itself (as a Max value, or a Min-to-Max value, or a difference of consecutive Delays, etc.) can vary depending on whichever layer (Ethernet layer or IP layer) it has been measured.

The present invention has a number of advantages some of which are as follows:

1. A provider can use the present invention and choose the originating MEP without being restricted to the root of a multicast tree, or to IP nodes.

2. The method 301 follows the downstream direction, ideally with 1-way measurements (i.e. D/DV measurement is closest to D/DV of actual BTV data). If only 2-way measurements are possible (no synchronized clocks), then the measured D/DV would not depend on the direction, but it would still be convenient and scalable to have a single originating point, i.e. to start from a single upstream point like the BNG 304.

3. The method 301 by adding an IP multicast group address (GA) in a L2 TLV allows one to target a specific L3 multicast traffic stream (i.e. a single TV channel) while using a L2 OAM NMS 306.

4. The present invention can be applied to different types of networks beside the IPTV network 300. Basically, the present invention can be applied in any application where an IP multicast transport is used in an Ethernet network.

A number of alternative embodiments that could possibly be used to measure the D/DV (Delay/Delay Variation) for a group of listeners of a BTV multicast stream that is associated with the IPTV network are discussed next. In one alternative embodiment, the IETF working group IPPM has defined various implementations of layer 3 IP measurements that allow one to obtain an one-to-group metric which can be applied, for instance, to a source-based multicast tree. For instance, IPPM has defined a Delay singleton as one set of group measurements: n receivers, one set of n Delays {D₁, D₂, . . . , Dₙ}. And, a Delay statistic has been defined, for instance, as an average of a group measurement: D=sum (D₁, D₂, . . . , Dₙ)/n. Thus, a group measurement could be built either on replicated unicast packets or directly from a multicast packet. However, when IP packets are used for group delay measurement, in both multicast and unicast cases, only IP nodes can be part of the measurement, which means that the customer service representative can not see details in Ethernet bridges or in non-IP-aware DSLAMs. Plus, when using unicast IP packets in the downstream direction, the measurement may be incorrect since the downstream unicast IP path may differ from the downstream multicast path. The reason for these different paths is that PIM or IGMP trees are built using RPF, i.e. along the upstream IP unicast paths. These paths happen to be the same if the physical topology is a tree, but they can be different in a mesh topology. Another problem with unicast IP packets is poor scalability where if the group has n listeners then a downstream measurement requires n probes to be issued from the same node in the downstream direction. Lastly, when using multicast packets, the L3 IP multicast measurement is limited to nodes which are enhanced with IPPM-compliant (or equivalent) multicast Delay measurement software or hardware. This is an expensive requirement, especially on RGWs in the residential customer premises.

In another alternative solution, mtrace is an in-band L3 multicast tool that was developed by multicast protocol designers, in experimental projects like MBONE (Multicast backbone), and adopted by some router vendors. It uses special IGMP messages containing several fields among which there is a Query Arrival Time field which can hold a time stamp. And, mtrace allows one to find the multicast path from a node to a source, plus it allows one to collect statistics about Delays and Loss. Moreover, mtrace measures the Delay for only one path, but if the measurement is repeated for each listener then it could provide the group delay by using a unicast replication scheme. Unfortunately, mtrace is a special case of L3 multicast tool where it is aware of multicast trees, but the measurement is unicast and upstream. Plus, mtrace requires the mrouted software to run on every router and every host it traverses. In addition, even though the mtrace can start from any node in the tree, it always goes up all the way to the source, without the possibility to stop at some arbitrary point downstream of the source (such as at the BNG). Another limitation of mtrace is that the reported one-way Delay is inaccurate, since it is based on time stamps captured by IGMP messages going upstream, without discarding IGMP processing delays, and usually without hardware-based time stamping. Moreover, mtrace is not standardized which may lead to interoperability issues. As such, the downstream one-way (or even two-way) delays experienced by actual multicast BTV traffic may not be efficiently measured by mtrace.

In yet another alternative embodiment, MEF 10-1 has defined three types of EVCs: point-to-point, multipoint-to-multipoint, and rooted-multipoint (i.e. point-to-multipoint) (see technical specification MEF 10.1). The latter two are groups, and the MEF has defined group metrics for them. Thus, if one considered all ingress and all egress frames (even if replicated by broadcast or multicast), a group delay could be essentially defined as D=max (Dᵢⱼ), and the group delay Variation could be defined as DV=max (DVᵢⱼ). These definitions are a bit more complex, since Dᵢⱼ and DVᵢⱼ are actually P-percentiles. However, MEF provides only definitions, not methods or processes which would be needed to address the present technical problem of measuring the D/DV for a group of listeners of a BTV multicast stream.

Although multiple embodiments of the present invention have been illustrated in the accompanying Drawings and described in the foregoing Detailed Description, it should be understood that the invention is not limited to the embodiments disclosed, but is capable of numerous rearrangements, modifications and substitutions without departing from the spirit of the invention as set forth and defined by the following claims.

1. A method for measuring a delay in a multicast stream for a group of listeners in an IP network, said method comprising the steps of:
sending a layer 2 multicast message with a first transmit time and a multicast address of the multicast stream from an originating node towards a plurality of destination nodes; and
causing a layer 2 unicast message to be sent from each of the destination nodes that are listeners of the multicast stream, where each layer 2 unicast message includes the first transmit time, the multicast address of the multicast stream and additional timing information used to measure the delay in the multicast stream for the group of listeners.

2. The method of claim 1, wherein if the measured delay is 1-way from the originating node to the destination nodes and if the originating node has a MEP in a first maintenance association and each destination node has a MEP in the first maintenance association then each layer 2 unicast message contains additional timing information which includes a first receive time indicative of a time when the corresponding MEP in the corresponding destination node received the layer 2 multicast message.

3. The method of claim 2, wherein said IP network is an IPTV network, said originating node is a broadband network gateway and said destination nodes are DSLAMs.

4. The method of claim 1, wherein if the measured delay is 2-way from the originating node to the destination nodes and back to the originating node and if the originating node has a MEP in a first maintenance association and each destination node has a MEP in the first maintenance association then each layer 2 unicast message contains additional timing information which includes:
a first receive time indicative of a time when the corresponding MEP in the corresponding destination node received the layer 2 multicast message;
a second transmit time indicative of a time when the corresponding MEP in the corresponding destination node transmitted the layer 2 unicast message; and
a second receive time indicative of a time when the MEP in the originating node received the layer 2 unicast message.

5. The method of claim 4, wherein said IP network is an IPTV network, said originating node is a broadband network gateway and said destination nodes are DSLAMs.

6. The method of claim 1, wherein if the measured delay is 1-way from the originating node to the destination nodes and if there is a intermediate node located between the originating node and the destination nodes and the originating node has a MEP in a first maintenance association and the intermediate node has a MEP in the first maintenance association and also has another MEP in a second maintenance association and each destination node has a MEP in the second maintenance association then each layer 2 unicast message contains additional timing information which includes:
a first receive time indicative of a time when the MEP in the intermediate node received the layer 2 multicast message;
a second transmit time indicative of a time when the another MEP in the intermediate node transmitted the layer 2 multicast message; and
a second receive time indicative of a time when the corresponding MEP in the corresponding destination node received the layer 2 multicast message.

7. The method of claim 6, wherein said IP network is a IPTV network, said originating node is a broadband network gateway, said intermediate node is a DSLAM and said destination nodes are residential gateways.

8. The method of claim 6, wherein said intermediate node aggregates at least a portion of the timing information in the layer 2 unicast messages received from the destination nodes and transmits a single layer 2 unicast message towards the originating node or a network management system.

9. The method of claim 6, wherein said intermediate node performs an interworking function so the MEP can handover the layer 2 multicast message to the another MEP.

10. The method of claim 1, wherein if the measured delay is 2-way from the originating node to the destination nodes and if there is a intermediate node located between the originating node and the destination nodes and the originating node has a MEP in a first maintenance association and the intermediate node has a MEP in the first maintenance association and also has another MEP in a second maintenance association and each destination node has a MEP in the second maintenance association then each layer 2 unicast message contains additional timing information which includes:
a first receive time indicative of a time when the MEP in the corresponding intermediate node received the layer 2 multicast message;
a second transmit time indicative of a time when the another MEP in the intermediate node transmitted the layer 2 multicast message;
a second receive time indicative of a time when the corresponding MEP in the corresponding destination node received the layer 2 multicast message;
a third transmit time indicative of a time when the corresponding MEP in the corresponding destination node transmitted the layer 2 unicast message;
a third receive time indicative of a time when the another MEP in the intermediate node received the layer 2 unicast message;
a fourth transmit time indicative of a time when the MEP in the intermediate node transmitted the layer 2 unicast message; and
a fourth receive time indicative of a time when the MEP in the originating node received the layer 2 unicast message.

11. The method of claim 10, wherein said IP network is a IPTV network, said originating node is a broadband network gateway, said intermediate node is a DSLAM and said destination nodes are residential gateways.

12. The method of claim 10, wherein said intermediate node performs a first interworking function so the MEP can handover the layer 2 multicast message to the another MEP and also performs a second interworking function so the another MEP can handover the layer 2 unicast message to the MEP.

13. The method of claim 1, wherein at least one of the destination nodes or an intermediate node utilizes a randomized latency delay mechanism to send the corresponding layer 2 unicast message.

14. A network management system, comprising:
a processor;
a memory; and
instructions which are accessible from said memory and processable by said processor to enable the following:
instructing an originating node to send a layer 2 multicast message with a first transmit time and a multicast address of the multicast stream towards a plurality of destination nodes; and
causing each of the destination nodes that are listeners of the multicast stream to transmit a layer 2 unicast message which includes the first transmit time, the multicast address of the multicast stream and additional timing information which are used to measure a delay in the multicast stream for a group of listeners.

15. The network management system of claim 14, wherein said processor further facilitates receiving and analyzing the layer 2 unicast messages to measure the delay for the group of listeners.

16. The network management system of claim 14, wherein said processor further facilitates receiving a delay measurement report from the originating node which received the layer 2 unicast messages and analyzed the layer 2 unicast messages to generate the delay measurement report.

17. The network management system of claim 14, wherein if the measured delay is 1-way from the originating node to the destination nodes and if the originating node has a MEP in a first maintenance association and each destination node has a MEP in the first maintenance association then each layer 2 unicast message contains additional timing information which includes a first receive time indicative of a time when the corresponding MEP in the corresponding destination node received the layer 2 multicast message.

18. The network management system of claim 14, wherein if the measured delay is 2-way from the originating node to the destination nodes and back to the originating node and if the originating node has a MEP in a first maintenance association and each destination node has a MEP in the first maintenance association then each layer 2 unicast message contains additional timing information which includes:
a first receive time indicative of a time when the corresponding MEP in the corresponding destination node received the layer 2 multicast message;
a second transmit time indicative of a time when the corresponding MEP in the corresponding destination node transmitted the layer 2 unicast message; and
a second receive time indicative of a time when the MEP in the originating node received the layer 2 unicast message.

19. The network management system of claim 14, wherein if the measured delay is 1-way from the originating node to the destination nodes and if there is a intermediate node located between the originating node and the destination nodes and the originating node has a MEP in a first maintenance association and the intermediate node has a MEP in the first maintenance association and also has another MEP in a second maintenance association and each destination node has a MEP in the second maintenance association then each layer 2 unicast message contains additional timing information which includes:
a first receive time indicative of a time when the MEP in the intermediate node received the layer 2 multicast message;
a second transmit time indicative of a time when the another MEP in the intermediate node transmitted the layer 2 multicast message; and
a second receive time indicative of a time when the corresponding MEP in the corresponding destination node received the layer 2 multicast message.

20. The network management system of claim 14, wherein if the measured delay is 2-way from the originating node to the destination nodes and if there is a intermediate node located between the originating node and the destination nodes and the originating node has a MEP in a first maintenance association and the intermediate node has a MEP in the first maintenance association and also has another MEP in a second maintenance association and each destination node has a MEP in the second maintenance association then each layer 2 unicast message contains additional timing information which includes:
a first receive time indicative of a time when the MEP in the corresponding intermediate node received the layer 2 multicast message;
a second transmit time indicative of a time when the another MEP in the intermediate node transmitted the layer 2 multicast message;
a second receive time indicative of a time when the corresponding MEP in the corresponding destination node received the layer 2 multicast message;
a third transmit time indicative of a time when the corresponding MEP in the corresponding destination node transmitted the layer 2 unicast message;
a third receive time indicative of a time when the another MEP in the intermediate node received the layer 2 unicast message;
a fourth transmit time indicative of a time when the MEP in the intermediate node transmitted the layer 2 unicast message; and
a fourth receive time indicative of a time when the MEP in the originating node received the layer 2 unicast message.

21. An Internet Protocol Broadcast Television network, comprising:
a broadband network gateway;
an aggregation node coupled to said broadband network gateway;
a DSLAM, coupled via an Ethernet access network, to said aggregation node;
a residential gateway coupled to said DSLAM;
a network management system, coupled to said broadband network gateway, having a processor which accesses instructions from a memory and processes the instructions to enable the following:
instructing said broadband network gateway to send a layer 2 multicast DMM message with a first transmit time and a multicast address of the multicast stream towards said DSLAM; and
causing said DSLAM and in particular MEPs located therein that are listeners of the multicast stream to each transmit a layer 2 unicast DMR message which includes the first transmit time, the multicast address of the multicast stream and additional timing information which is used to measure a delay in the multicast stream for a group of listeners.
